(19) United States
(12) Patent Application Publication
(10) Pub. No.: US 2015/0189713 A1
(43) Pub. Date: Jul. 2, 2015

(54) LIGHT SOURCE MODULE AND LIGHT-EMITTING CONTROL METHOD

(71) Applicants: Qisda Optronics (Suzhou) Co., Ltd., Suzhou (CN); Qisda Corporation, Taoyuan (TW)

(72) Inventors: HUNG HUANG, Guishan Township (TW); WEN-YAO LIN, Taoyuan City (TW)

(21) Appl. No.: 14/571,125

(22) Filed: Dec. 15, 2014

(30) Foreign Application Priority Data
Dec. 26, 2013 (TW) 102148480

(51) Int. Cl. H05B 33/08; G03B 21/20; H05B 37/02

(52) U.S. Cl. CPC H05B 33/0845; H05B 37/0281; G03B 21/2053

(57) ABSTRACT

A light source module and a light-emitting control method are disclosed. The light source module includes light-emitting devices which periodically emit light by a period. The period includes time intervals corresponding to the light-emitting devices, respectively. The light-emitting control method includes driving each light-emitting device to emit light by an individual main power during its corresponding time interval, and driving each light-emitting device to emit light by a corresponding auxiliary power during each of the time intervals other than its corresponding time interval. Therein, for each time interval, the corresponding auxiliary power corresponding to the time interval is less than the individual main power of the light-emitting device corresponding to the time interval, and a value of the corresponding auxiliary power corresponding to the time interval divided by the individual main power of the light-emitting device corresponding to the time interval is not more than a corresponding limitation value.

### BACKGROUND OF THE INVENTION

1. Field of the Invention

The present invention relates to a light source module and a light-emitting control method thereof, and more particularly, to a light source module which emits light periodically and a light-emitting control method thereof which are applied in a projector.

2. Description of the Prior Art

The light-emitting diode (LED) is generally used in a projector as a light source, but the luminance of the light source decays as time goes by due to the material characteristics of the LED and the color of the projected image varies accordingly. The input current of the LED may be increased to compensate the luminance decay. However, the higher the input current is, the more heat the LED generates. It is then difficult to control the junction temperature of the LED and the life of the LED is decreased. Thus increasing the input current of the LED shortens the LED life and decreases the light-emitting efficiency, and the decay would happen sooner. The input current of the LED then needs to be increased again till the LED luminance decay can not be compensated or even until the LED is damaged or destroyed. If one avoids over-increasing the input current of the LED, the effect of luminance compensation is limited. Besides, if the LEDs with different colors are used in the light source module of the projector to emit light, these LEDs with different colors may decay to different extents and the current applied in each of these LEDs may need to be increased to different extent correspondingly. Although aforementioned method of luminance compensation may be applied to each of the LEDs with different colors for individual adjustment, it is not easy to maintain the luminance for each of the LEDs with different colors. Especially when one intends not to over-increase the input currents of the LEDs with different colors, luminance decay of these LEDs may not be completely compensated. It would cause the luminance proportion of the LEDs with different colors to be varying more after adjustment compared with the luminance uniformity or proportion before adjustment, and the color distortion then occurs to the projected image.

### SUMMARY OF THE INVENTION

One of the purposes of this invention is to provide a light-emitting control method to control a plurality of light-emitting devices to emit light so that each light-emitting device not only emits light during its own duty cycle but also emits light during the duty cycles of other light-emitting devices. The luminance of the light-emitting devices therefore can be adjusted. Meanwhile one can avoid over-increasing the input current of the light-emitting devices to shorten the life of the light-emitting devices.

According to one embodiment, the light-emitting control method of this invention is applied to a light source module which comprises a plurality of light-emitting devices. The plurality of light-emitting devices periodically emit light by a period. The period comprises a plurality of time intervals, and the plurality of time intervals correspond to the plurality of light-emitting devices, respectively. The light-emitting control method comprising: driving each light-emitting device to emit light by an individual main power during its corresponding time interval; and driving each light-emitting device to emit light by a corresponding auxiliary power during each of the time intervals other than its corresponding time interval, wherein for each time interval each of the corresponding auxiliary powers corresponding to the time interval is less than the individual main power of the light-emitting device corresponding to the time interval, and a value of the corresponding auxiliary power corresponding to the time interval divided by the individual main power of the light-emitting device corresponding to the time interval is not more than a corresponding limitation value. By this method, the luminance of the light source module can be adjusted. Besides, the method can further increase the individual main power for driving each of the light-emitting devices to emit light so that the luminance of the light source module can be further adjusted.

Another purpose of this invention is to provide a light source module in which the light-emitting control method according to the embodiment of the invention is applied. According to another embodiment, the light source module comprises a plurality of light-emitting devices and a controller, and the controller is electrically connected to the plurality of light-emitting devices. The controller controls the plurality of light-emitting devices to periodically emit light by a period. The period comprises a plurality of time intervals. The plurality of time intervals correspond to the plurality of light-emitting devices, respectively. The controller drives each light-emitting device to emit light by an individual main power during its corresponding time interval, and drives each light-emitting device to emit light by a corresponding auxiliary power during each of the time intervals other than its corresponding time interval. For each time interval, each of the corresponding auxiliary powers which correspond to the time interval is less than the individual main power of the light-emitting device which corresponds to the time interval. A value of the corresponding auxiliary power corresponding to the time interval divided by the individual main power of the light-emitting device corresponding to the time interval is not more than a corresponding limitation value. The luminance of the light source module can thus be adjusted. Besides, the individual main power can be further increased for driving each of the light-emitting devices to emit light so that the luminance of the light source module can be further adjusted as well.

Compared with the prior art, the light-emitting device according to this invention not only emits light during its own duty cycle, i.e. the time interval corresponding to the light-emitting device, but also emits light during the duty cycles of the other light-emitting devices, i.e. the time intervals corresponding to the other light-emitting devices. The luminance of the light source module therefore can be adjusted. In other words, based on the light-emitting control method according to this invention, the luminance of the light source module may be adjusted without increasing the power of each light-emitting device during its duty cycle. One therefore can avoid over-increasing the input current of the light-emitting device which may result in life decrease of the light-emitting device. Moreover, based on this invention during each time interval the valued of the corresponding auxiliary power divided by the individual main power is controlled not to exceed the limitation value so as not to cause the color distortion or deviation. Therefore, both the increase of the luminance and the stability of the color are taken into consideration according to this invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a light source module according to an embodiment of the present invention.

FIG. 2 is a light-emitting timing diagram of the light source module shown in FIG. 1 before adjustment.

FIG. 3 is a flow chart of a light-emitting control method according to an embodiment of the present invention.

FIG. 4 is a light-emitting timing diagram of the light source module shown in FIG. 1 after the first stage adjustment.

FIG. 5 is a light-emitting timing diagram of the light source module shown in FIG. 1 after the second stage adjustment.

FIG. 6 is a flow chart of a light-emitting control method according to another embodiment of the present invention.

FIG. 7 is a light-emitting timing diagram of the light source module shown in FIG. 1 based on the first stage adjustment using the light-emitting control method of the flow chart shown in FIG. 6.

FIG. 8 is a light-emitting timing diagram of the light source module shown in FIG. 1 based on the second stage adjustment using the light-emitting control method of the flow chart shown in FIG. 6.

### DETAILED DESCRIPTION OF PREFERRED EMBODIMENTS

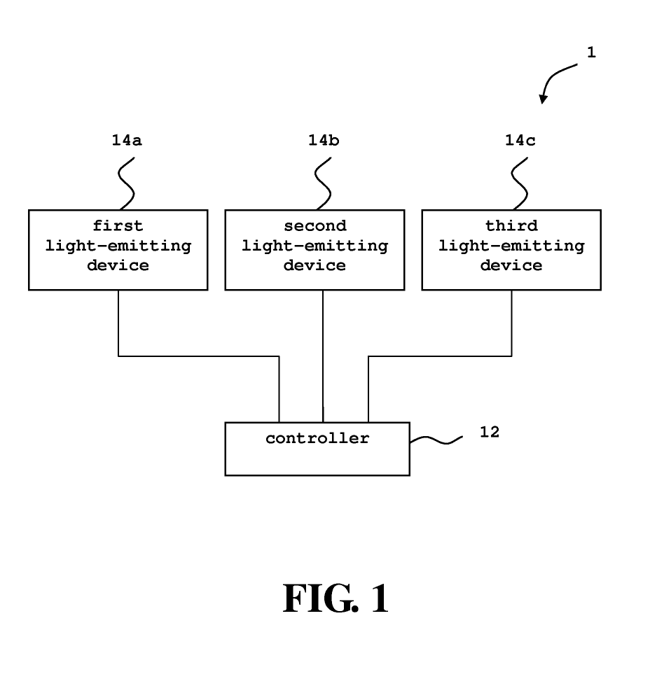

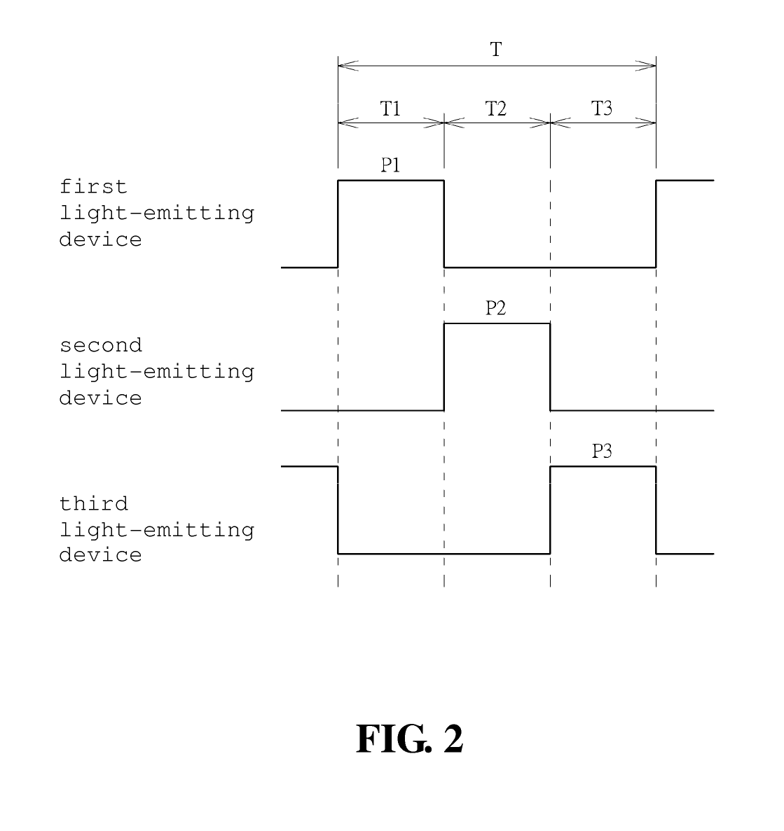

Please refer to FIG. 1 and FIG. 2. FIG. 1 is a block diagram of a light source module 1 according to an embodiment of the present invention. FIG. 2 is a light-emitting timing diagram of the light source module 1 shown in FIG. 1 before adjustment. The light source module comprises a controller 12 and a plurality of light-emitting devices. The plurality of light-emitting devices periodically emit light by a period T. The controller 12 is electrically connected to the plurality of light-emitting devices and controls the plurality of light-emitting devices to emit light. In the present embodiment, the plurality of light-emitting devices comprises a first light-emitting device 14a, a second light-emitting device 14b and a third light-emitting device 14c, each of which emits different light, such as the red light, the green light and the blue light, respectively, but the invention is not so limited. In practical application, the number of the light-emitting devices and the number of the colors of the light depend on the application requirement. For example, when the light source module 1 is applied in a projector, four or six light-emitting devices may be used to emit light with four or six colors. Moreover, the first light-emitting device 14a, the second light-emitting device 14b and the third light-emitting device 14c may be implemented by the LEDs but are not so limited. Corresponding to the number of the plurality of light-emitting devices, the period T also comprises a plurality of time intervals. In the present embodiment, the period T comprises a first time interval T1, a second time interval T2 and a third time interval T3. Before the powers of the light-emitting devices 14a, 14b and 14c are adjusted, the controller 12 drives each of the light-emitting devices 14a, 14b and 14c to emit light by a plurality of individual main powers P1, P2 and P3 only during the corresponding time intervals T1, T2 and T3, i.e. the corresponding duty cycles, respectively. The aforementioned individual main powers P1, P2 and P3 may be the powers which were set in advance by the manufacturer or decided by a user through the menu of the on-screen display. When the light source module 1 is used for a period of time, the light-emitting efficiency of the LEDs decreases and the luminance of the light-emitting devices 14a, 14b and 14c decreases accordingly. At this moment, the light-emitting control method according to embodiments of this invention can be applied to compensate the luminance.

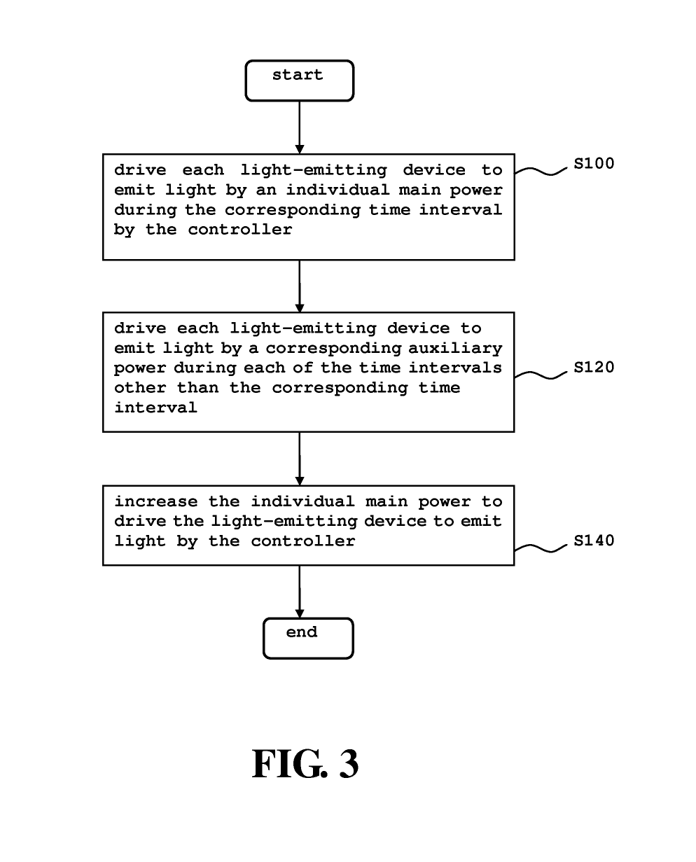

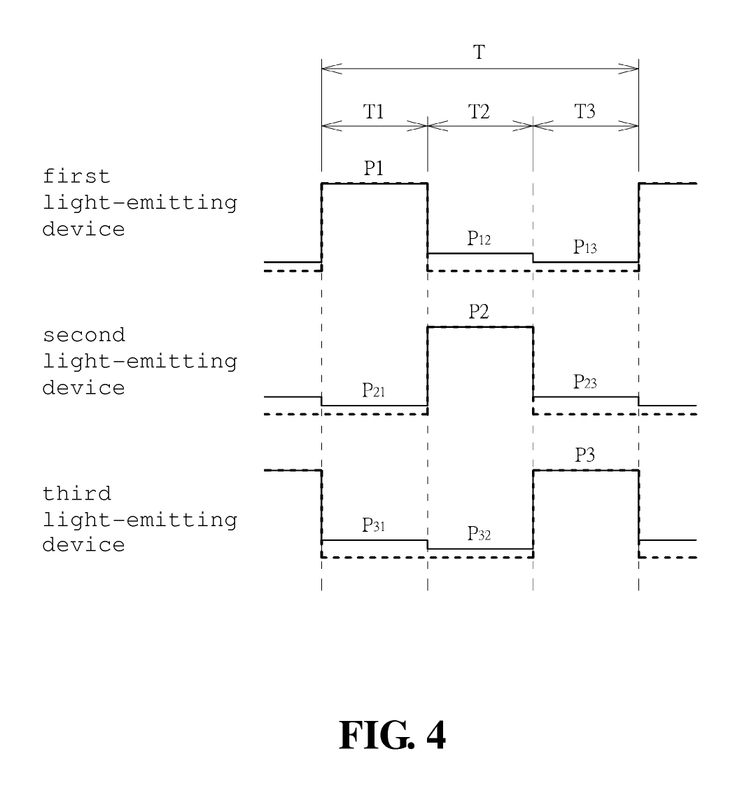

Please refer to FIG. 3. FIG. 3 is a flow chart of a light-emitting control method according to an embodiment of the present invention. In the present embodiment, the controller 12 is used to drive each of the light-emitting devices 14a, 14b and 14c to emit light by the individual main powers P1, P2 and P3 during the corresponding time intervals T1, T2 and T3, respectively, as shown in the step S100. At this time, the light-emitting powers of the light-emitting devices 14a, 14b and 14c are shown in FIG. 2. When the luminance of the light source module 1 decays due to the decrease of the light-emitting efficiency of the LEDs after usage for a period of time, the light-emitting control method according to this invention uses the controller 12 to drive each of the light-emitting devices 14a, 14b and 14c to emit light by a corresponding auxiliary power during each of the time intervals other than its corresponding time interval as shown in the step S120. At this time, a first stage adjustment has been implemented to the light-emitting devices 14a, 14b and 14c and the light-emitting powers of the light-emitting devices 14a, 14b and 14c are shown in FIG. 4 in which the light-emitting powers before adjustment are shown as the dotted lines. In the present embodiment, after the light source module 1 is adjusted based on the step S120, the light-emitting device 14a emits light by the individual main power P1 during the first time interval T1, emits light by the corresponding auxiliary power P₁₂ during the second time interval T2 and emits light by the corresponding auxiliary power P₁₃ during the third time interval T3. The light-emitting device 14b emits light by the corresponding auxiliary power P₂₁ during the first time interval T1, emits light by the individual main power P2 during the second time interval T2 and emits light by the corresponding auxiliary power P₂₃ during the third time interval T3. The light-emitting device 14c emits light by the corresponding auxiliary power P₃₁ during the first time interval T1, emits light by the corresponding auxiliary power P₃₂ during the second time interval T2 and emits light by the individual main power P3 during the third time interval T3. In practical application, to avoid color shift after adjustment, during each of the time intervals T1, T2 and T3, the value of a ratio of each corresponding auxiliary power divided by the individual main power does not exceed a corresponding limitation value. The limitation value can be presented in the form of Pᵢⱼ/Pj<Cᵢⱼ, wherein i and j are in the range from 1 to 3 and i≠j, and When j=1, 2 and 3, Pj is P1, P2 and P3, respectively. Since the relationship between the light-emitting power and luminance for each LED may be different, the luminance compensation effect or influence of the corresponding auxiliary power on each of the light-emitting devices 14a, 14b and 14c varies accordingly. Therefore, each limitation value Cᵢⱼ may be different. In another embodiment, each limitation value Cᵢⱼ may be set as the same value. For example, in practical application, for each of the time intervals T1, T2 and T3, the value of the ratio of each corresponding auxiliary power divided by the individual main power, i.e. Pᵢⱼ/Pj, can be set the same to simplify the control. All the values Pᵢⱼ/Pj may even be set to be the same constant when it is proper. Further, to avoid color distortion after adjustment, the total powers consumed in a period T among the light-emitting devices 14a, 14b and 14c both before and after adjustment may be maintained in a predetermined proportion or in an allowable deviation range. In other words, the power ratio after adjustment P1+P₁₂+P₁₃:P₂₁+P2+P₂₃:P₃₁+P₃₂+P3 is controlled to be substantially equal to the power ratio before adjustment P1:P2:P3, or the difference between the power ratios is controlled to be within an allowable tolerance. Alternatively, the ratio of the power increased in a period T for each of the light-emitting devices 14a, 14b and 14c may be maintained substantially the same, which can be presented in the following equation: (P₁₂+P₁₃)/P1=(P₂₁+P₂₃)/P2=(P₃₁+P₃₂)/P3.

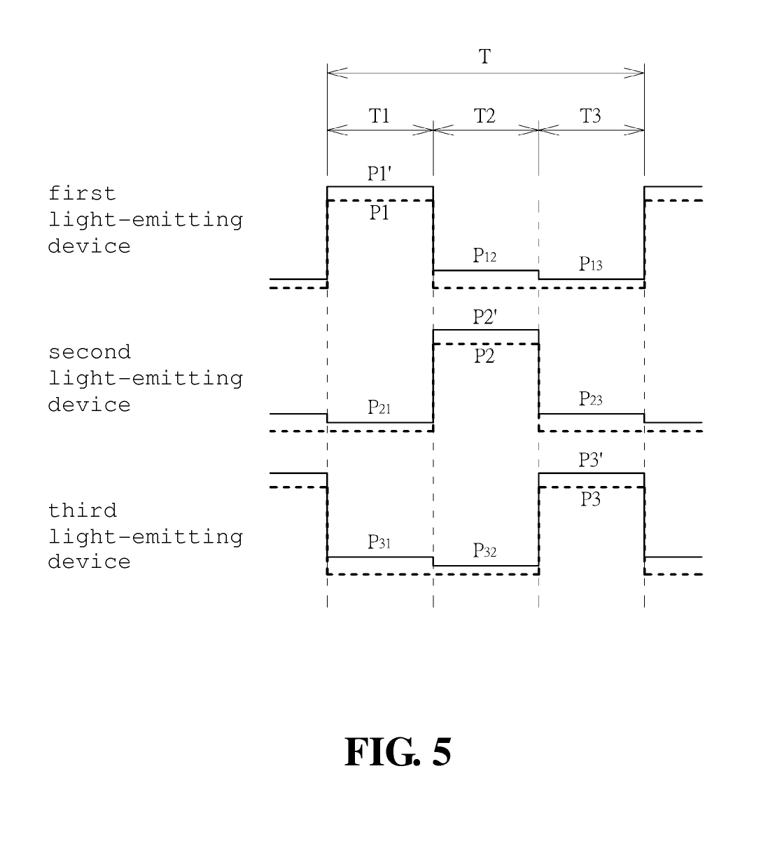

After the first stage adjustment of the light source module 1, each of the light-emitting devices 14a, 14b and 14c is driven to additionally emit light by the corresponding auxiliary power Pᵢⱼ (i≠j, and in the present embodiment I and j are in the range from 1 to 3) during the time intervals other than the duty cycle so as to increase the whole light-emitting power of the light source module 1 and to adjust for or compensate the luminance decay of the light source module 1. After the light source module 1 is used for a period of time, the luminance of the light source module 1 may decay and need to be adjusted again. In practical application, while the step S220 may be repeated again and again to compensate the decayed luminance, when the value of the corresponding auxiliary power divided by the individual main power during a time interval already reaches the corresponding limitation value, i.e. Pᵢⱼ/Pj=Cᵢⱼ (i≠j, and in the present embodiment I and j are in the range from 1 to 3), based on the light-emitting control method according to this invention, the controller 12 can increase the corresponding individual main power P1, P2 and P3 to drive the light-emitting devices 14a, 14b and 14c to emit light, respectively, as shown in the step S140. In other words, the light-emitting devices 14a, 14b and 14c emit light by the increased individual main powers P1′, P2′ and P3′ during the corresponding time intervals T1, T2 and T3, respectively. At this moment, the light-emitting powers of the light-emitting devices 14a, 14b and 14c are shown in FIG. 5 as the solid lines. The light-emitting powers of the light-emitting devices 14a, 14b and 14c before adjustment are also shown in FIG. 5 as the dotted lines. Similarly, to avoid color distortion after adjustment, the power consumed in a period T among the light-emitting devices 14a, 14b and 14c may be maintained in a predetermined proportion. Or in a different way of description, the individual main powers consumed in the period T among the light-emitting devices 14a, 14b and 14c before adjustment and after adjustment are maintained in substantially the same proportion or in an allowable deviation range. That is, the consumed power proportion after adjustment P1′+P₁₂+P₁₃:P₂₁+P2′+P₂₃:P₃₁+P₃₂+P3′ is substantially the same as the consumed power proportion before adjustment P1+P₁₂+P₁₃:P₂₁+P2+P₂₃:P₃₁+P₃₂+P3, or the relationship is presented in the following equation: (P1′+P₁₂+P₁₃)/(P1+P₁₂+P₁₃)=(P2′+P₂₁+P₂₃)/(P₂₁+P2+P₂₃)=(P3′+P₃₁+P₃₂)/(P₃₁+P₃₂+P3). Please note that in practical application the consumed power has an upper limit for each of the light-emitting devices 14a, 14b and 14c, and the increased individual main powers P1′, P2′ and P3′ therefore are not supposed to exceed the corresponding upper limits.

After the second stage adjustment of the light source module 1, the light-emitting devices 14a, 14b and 14c are driven to emit light during the corresponding duty cycles, i.e. the corresponding time intervals T1, T2 and T3, by the increased individual main powers P1′, P2′ and P3′, respectively, to increase the whole luminance of the light source module 1 so as to compensate the decayed luminance. Please note that while in aforementioned embodiment all the light-emitting devices 14a, 14b and 14c are adjusted, but this invention is not so limited. Moreover, once the luminance decay of the light source module 1 occurs again, since the light-emitting devices 14a, 14b and 14c have been driven to emit light during the corresponding time intervals T1, T2 and T3 by the increased individual main powers P1′, P2′ and P3′, respectively, the value of the corresponding auxiliary power Pᵢⱼ divided by the increased individual main power Pj′ (i≠j, and in the present embodiment I and j are in the range from 1 to 3) decreases. Under this situation, the step S120 can be executed again by further increasing the corresponding auxiliary powers Pᵢⱼ. Similarly, to avoid color shift after adjustment, during each of the time intervals T1, T2 and T3, the value of the ratio of each increased corresponding auxiliary power Pᵢⱼ divided by the increased individual main power Pj should be less than the corresponding limitation value Cᵢⱼ, i.e. Pᵢⱼ/Pj<Cᵢⱼ, wherein I and j are in the range from 1 to 3 and i≠j.

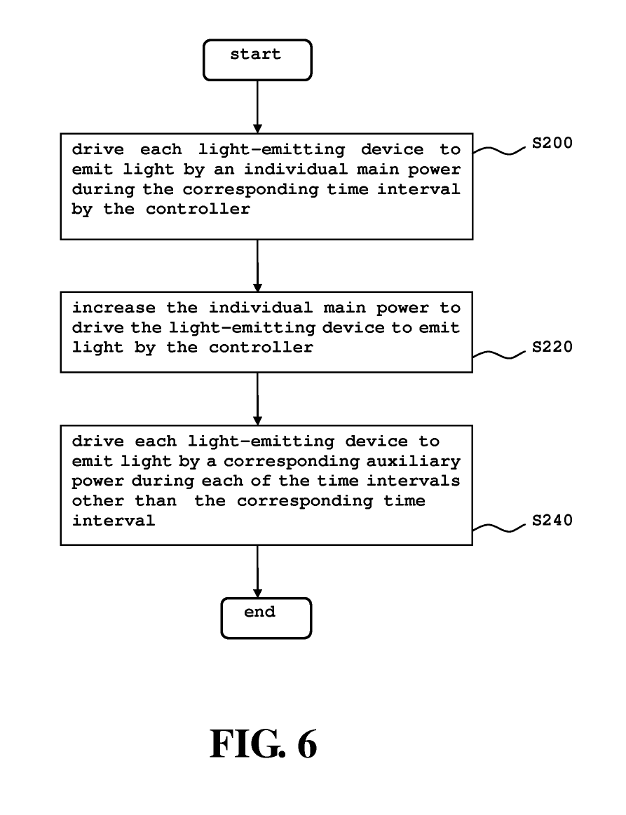

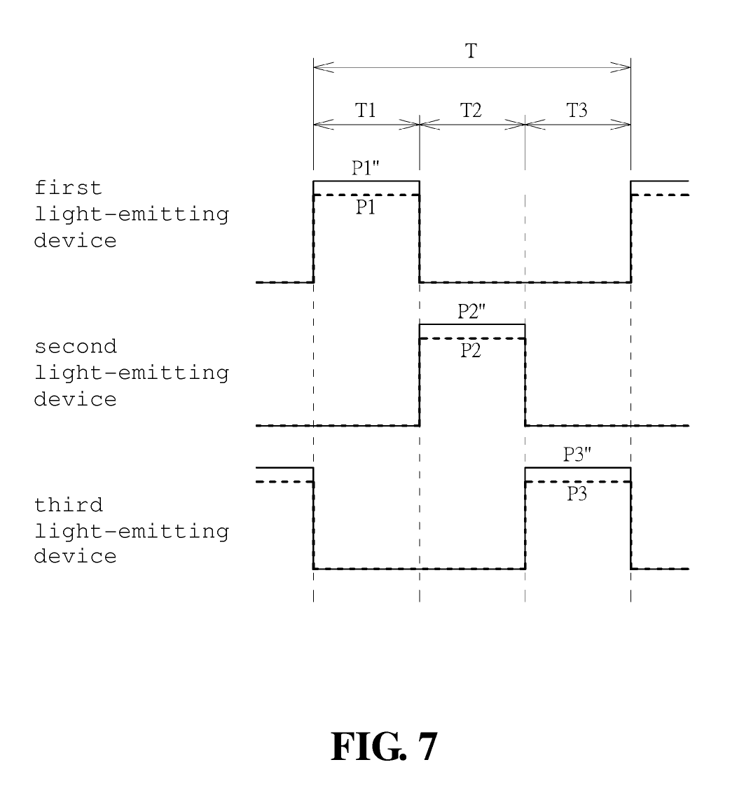

Please note that during aforementioned consequent adjustments, the corresponding auxiliary power, i.e. the power during the time intervals other than the duty cycle, is first used and the individual main power, i.e. the power during the duty cycle, is then increased so as to execute the first and the second stage adjustments, but the invention is not so limited. In practical application, it also works that for each of the light-emitting devices 14a, 14b and 14c the individual main power during the duty cycle is increased first, and the corresponding auxiliary power during the time intervals other than the duty cycle is then used so as to increase the whole luminance of the light source module 1. Please refer to FIG. 1, FIG. 2 and FIG. 6. FIG. 6 is a flow chart of a light-emitting control method according to another embodiment of the present invention. In the present embodiment, the controller 12 drives each of the light-emitting devices 14a, 14b and 14c to emit light by the individual main powers P1, P2 and P3 during the corresponding time intervals T1, T2 and T3, i.e. the corresponding duty cycles, respectively, as shown in the step S200. At this time, the light-emitting powers of the light-emitting devices 14a, 14b and 14c are shown in FIG. 2. When the whole luminance of the light source module 1 decays, the controllers 12 increase the individual main powers P1, P2 and P3 for the light-emitting devices 14a, 14b and 14c , respectively, as shown in the step S220. In other words, the light-emitting devices 14a, 14b and 14c emit light by the increased individual main powers P1″, P2″ and P3″ during the corresponding time interval T1, T2 and T3, respectively. The powers of the light-emitting devices 14a, 14b and 14c are shown in FIG. 7 as the solid lines, and the powers before adjustment are shown as the dotted lines. To avoid color distortion after adjustment, the powers consumed in a period T among the light-emitting devices 14a, 14b and 14c may be maintained in a predetermined proportion or in an allowable deviation range. In other words, the power ratio after adjustment P1″:P2″:P3″ is controlled to be substantially equal to the power ratio before adjustment P1:P2:P3, or the difference between the ratios is controlled to be within an allowable tolerance. Similarly, the consumed power has an upper limit for each of the light-emitting devices 14a, 14b and 14c, and the increased individual main powers P1″, P2″ and P3″ are not supposed to exceed the corresponding upper limits.

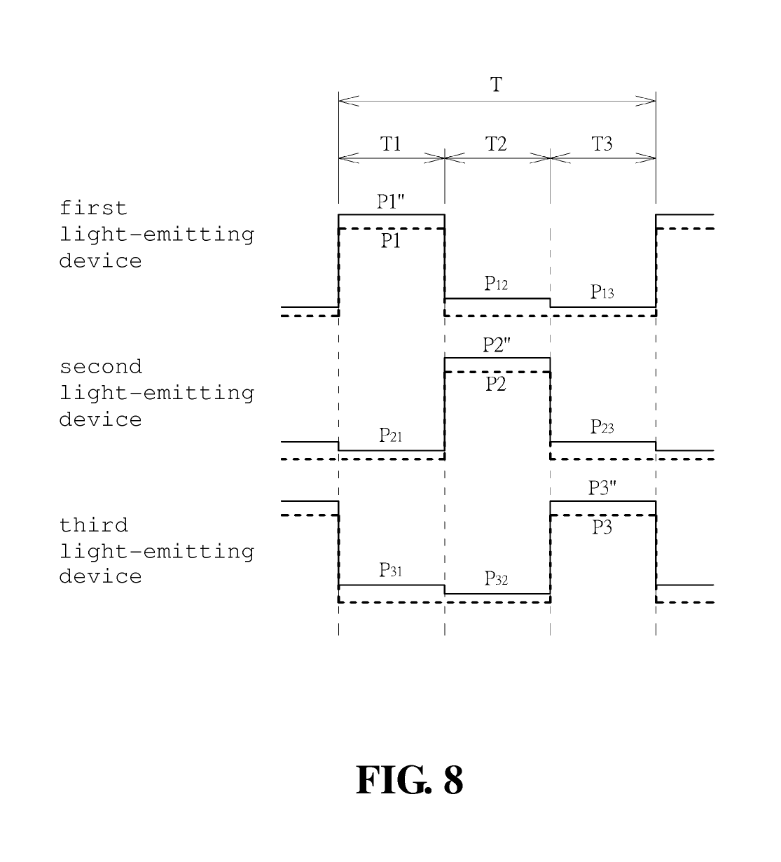

At this moment, in this embodiment the first stage adjustment of the light source module 1 has been implemented, i.e. the light-emitting devices 14a, 14b and 14c are driven to emit light during the corresponding duty cycles, i.e. the corresponding time intervals T1, T2 and T3, by the increased individual main powers P1″, P2″ and P3″, respectively, to increase the whole luminance of the light source module 1 so as to compensate the decayed luminance. As previously explained, the increased individual main powers P1″, P2″ and P3″ are not supposed to exceed the corresponding upper limits. Similarly, after the light source module 1 is used for a period of time, the luminance of the light source module 1 may decay and need to be adjusted again. The light-emitting control method according to this invention uses the controller 12 to drive each of the light-emitting devices 14a, 14b and 14c to emit light by a corresponding auxiliary power during each of the time intervals other than its corresponding time interval as shown in the step S240. In the present embodiment, after the light source module 1 is adjusted based on the step S240, the light-emitting device 14a emits light by the individual main power P1″ during the first time interval T1, emits light by the corresponding auxiliary power P₁₂ during the second time interval T2 and emits light by the corresponding auxiliary power P₁₃ during the third time interval T3. The light-emitting device 14b emits light by the corresponding auxiliary power P₂₁ during the first time interval T1, emits light by the individual main power P2″ during the second time interval T2 and emits light by the corresponding auxiliary power P₂₃ during the third time interval T3. The light-emitting device 14c emits light by the corresponding auxiliary power P₃₁ during the first time interval T1, emits light by the corresponding auxiliary power P₃₂ during the second time interval T2 and emits light by the individual main power P3″ during the third time interval T3. The powers of the light-emitting devices 14a, 14b and 14c after adjustment are shown in FIG. 8 as the solid lines, and these before adjustment are shown as the dotted lines. To avoid color shift after adjustment, during each of the time intervals T1, T2 and T3, the value of the ratio of each corresponding auxiliary power divided by the individual main power does not exceed a corresponding limitation value. The limitation value can be presented in the form of Pᵢⱼ/Pj″<Cᵢⱼ, wherein in the embodiment i and j are in the range from 1 to 3 and i≠j, and When j=1, 2 and 3, Pj is P1″, P2″ and P3″, respectively. In practical application, since the relationship between the light-emitting power and luminance for each LED may be different, the influence of the corresponding auxiliary power on each of the light-emitting devices 14a, 14b and 14c varies accordingly. Therefore, each limitation value Cᵢⱼ may be different. Further, to avoid color distortion after adjustment, the total powers consumed in a period T among the light-emitting devices 14a, 14b and 14c both before and after adjustment may be maintained in a predetermined proportion or in a allowable deviation range. In other words, the power ratio after adjustment P1″+P₁₂+P₁₃:P₂₁+P2″+P₂₃:P₃₁+P₃₂+P3″ is controlled to be substantially equal to the power ratio before adjustment P1+P₁₂+P₁₃:P₂₁+P2+P₂₃:P₃₁+P₃₂+P3, or the difference between the ratios is controlled to be within an allowable tolerance. Alternatively, the ratio relationship may be presented in the following equation: maintained substantially the same, which can be presented in the following equation: (P1″+P₁₂+P₁₃)/(P1+P₁₂+P₁₃)=(P²″+P₂₁+P₂₃)/(P₂₁+P2+P₂₃)=(P3″+P₃₁+P₃₂)/(P₃₁+P₃₂+P3). Regarding the detailed explanation about Pᵢⱼ/Pj″ and Cᵢⱼ, please refer to aforementioned embodiments.

At this moment, the light source module 1 has been adjusted based on the second stage adjustment. Each of the light-emitting devices 14a, 14b and 14c is driven to additionally emit light by the corresponding auxiliary power Pᵢⱼ (i≠j, and in the present embodiment I and j are in the range from 1 to 3) during the time intervals other than the duty cycle so as to increase the whole light-emitting power and to compensate the luminance decay of the light source module 1. In brief, in the present embodiment during the consequent adjustments the individual main power, i.e. the power consumed during the duty cycle, is first increased, and the corresponding auxiliary power, i.e. the power consumed during the time intervals other than the duty cycle, is then used so as to execute the first stage adjustment and the second stage adjustment, respectively.

Please note that in previous embodiments the individual main power, i.e. the power consumed during the duty cycle, and the corresponding auxiliary power, i.e. the power consumed during the time interval other than the duty cycle, are increased or used one at a time, but in practical application both can be increased or used at the same time or by turns. Besides, no matter what is increased or used as being the individual main power or the corresponding auxiliary power, there is no need to increase the power to the upper limit. Therefore in previous embodiments each step can be repeated. In previous embodiments, while a plurality of luminance decays are taken for examples, in practical application it is enough to execute required step(s) till the decayed luminance is compensated, and not all steps are supposed to be executed. Further, the decayed luminance may be detected by other device to trigger the light-emitting control method according to this invention, but in practical application the decayed luminance may be predicted based on past experiences or trials of the same light source modules so that automatic adjustment is also available according to this invention.

As explained above, the light-emitting device according to this invention not only emits light during its own duty cycle but also emits light during the duty cycles of other light-emitting devices to adjust the whole luminance of the light source module. In other words, through the light-emitting control method according to this invention, the luminance of the light source module can be adjusted without increasing the light-emitting power during the duty cycle for each light-emitting device. It therefore can avoid over-increasing the input current of the light-emitting device to shorten the life time or lifespan of the light-emitting device and the light source module. Moreover, in the invention the value of the corresponding auxiliary power divided by the individual main power is controlled not to exceed the corresponding limitation value so that both the increase of the luminance and the stability of the color are taken into consideration and the color shift would not occur.

Those skilled in the art will readily observe that numerous modifications and alterations of the device and method may be made while retaining the teachings of the invention.

What is claimed is:

1. A light-emitting control method applied to a light source module comprising a plurality of light-emitting devices, the plurality of light-emitting devices periodically emit light by a period, the period comprising a plurality of time intervals, the plurality of time intervals corresponding to the plurality of light-emitting devices, respectively, the light-emitting control method comprising:
(a) driving each light-emitting device to emit light by an individual main power during its corresponding time interval; and
(b) driving each light-emitting device to emit light by a corresponding auxiliary power during each of the time intervals other than its corresponding time interval, wherein for each time interval each of the corresponding auxiliary powers corresponding to the time interval is less than the individual main power of the light-emitting device corresponding to the time interval, and a value of the corresponding auxiliary power corresponding to the time interval divided by the individual main power of the light-emitting device corresponding to the time interval is not more than a corresponding limitation value.

2. The light-emitting control method of claim 1, wherein for each of the light-emitting devices, a sum of the corresponding auxiliary powers divided by the individual main power is the same.

3. The light-emitting control method of claim 1, wherein when the value of each of the corresponding auxiliary powers corresponding to the time interval divided by the individual main power of the light-emitting device corresponding to the time interval is equal to the corresponding limitation value, after the step (b) further comprising:
increasing the individual main power for each of the light-emitting devices, wherein for each of the light-emitting devices a sum of the corresponding auxiliary powers and the increased individual main power divided by a sum of the corresponding auxiliary powers and the individual main power not increased yet is the same.

4. The light-emitting control method of claim 1, before the step (b) further comprising:
increasing the individual main power for each of the light-emitting devices, wherein for each of the light-emitting devices the increased individual main power divided by the individual main power not increased yet is the same.

5. The light-emitting control method of claim 1, wherein the plurality of light-emitting devices comprise three light-emitting devices which emit red light, green light and blue light, respectively.

6. The light-emitting control method of claim 1, wherein the plurality of light-emitting devices are a plurality of light-emitting diodes.

7. The light-emitting control method of claim 1, wherein an input current is controlled to drive each light-emitting device to emit light.

8. A light source module comprising:
a plurality of light-emitting devices periodically emitting light by a period, the period comprising a plurality of time intervals, and the plurality of time intervals corresponding to the plurality of light-emitting devices, respectively; and
a controller electrically connected to the plurality of light-emitting devices and controlling the plurality of light-emitting devices to emit light, the controller driving each light-emitting device to emit light by an individual main power during its corresponding time interval, and the controller driving each light-emitting device to emit light by a corresponding auxiliary power during each of the time intervals other than its corresponding time interval, wherein for each time interval each of the corresponding auxiliary powers corresponding to the time interval is less than the individual main power of the light-emitting device corresponding to the time interval, and a value of the corresponding auxiliary power corresponding to the time interval divided by the individual main power of the light-emitting device corresponding to the time interval is not more than a corresponding limitation value.

9. The light source module of claim 8, wherein for each of the light-emitting devices a sum of the corresponding auxiliary powers divided by the individual main power is the same.

10. The light source module of claim 8, wherein when the value of each of the corresponding auxiliary powers corresponding to the time interval divided by the individual main power of the light-emitting device corresponding to the time interval is equal to the corresponding limitation value, the controller increases the individual main power for each of the light-emitting devices, and for each of the light-emitting devices a sum of the corresponding auxiliary powers and the increased individual main power divided by a sum of the corresponding auxiliary powers and the individual main power not increased yet is the same.

11. The light source module of claim 8, wherein the controller increases the individual main power for each of the light-emitting devices, and for each of the light-emitting devices the increased individual main power divided by the individual main power not increased yet is the same.

12. The light source module of claim 8, wherein the plurality of light-emitting devices comprise three light-emitting devices which emit red light, green light and blue light, respectively.

13. The light source module of claim 8, wherein the plurality of light-emitting devices are a plurality of light-emitting diodes.

14. The light source module of claim 8, wherein the controller controls an input current for each light-emitting device to drive each light-emitting device to emit light.
